(19) United States
(12) Patent Application Publication
(10) Pub. No.: US 2008/0296388 A1
(43) Pub. Date: Dec. 4, 2008

(54) Compact, ergonomic imaging reader and method

(76) Inventors: Mark Drzymala, Commack, NY (US); Edward Barkan, Miller Place, NY (US)

Correspondence Address: KIRSCHSTEIN, OTTINGER, ISRAEL;& SCHIFFMILLER, P.C., 425 FIFTH AVENUE, 5TH FLOOR, NEW YORK, NY, 10016-2223, US

(21) Appl. No.: 11/807,946

(22) Filed: May 30, 2007

(51) Int. Cl. G06K 7/10

(52) U.S. Cl. 235/462.42

(57) ABSTRACT

A target is illuminated with light for image capture by a solid-state imager of an imaging reader over a tall field of view having an aspect ratio whose vertical dimension is larger than its horizontal dimension during image capture. The reader is pivotably mounted in a stand and has a narrow depth to enable a user to easily grasp the reader.

### BACKGROUND OF THE INVENTION

1. Field of the Invention

The present invention generally relates to an electro-optical reader for reading indicia, especially two-dimensional indicia, by using a solid-state imager for image capture over a field of view.

2. Description of the Related Art

Flat bed laser readers, also known as horizontal slot scanners, have been used to electro-optically read one-dimensional bar code symbols, particularly of the Universal Product Code (UPC) type, at a point-of-transaction workstation in supermarkets, warehouse clubs, department stores, and other kinds of retailers for many years. As exemplified by U.S. Pat. No. 5,059,779; U.S. Pat. No. 5,124,539; and U.S. Pat. No. 5,200,599, a single, horizontal window is set flush with, and built into, a horizontal countertop of the workstation. Products to be purchased bear an identifying symbol and are typically slid or swiped across the horizontal window through which a multitude of scan lines is projected in a generally upwards direction. When at least one of the scan lines sweeps over a symbol associated with a product, the symbol is processed and read.

The multitude of scan lines is generated by a scan pattern generator which includes a laser for emitting a laser beam at a mirrored component mounted on a shaft for rotation by a motor about an axis. A plurality of stationary mirrors is arranged about the axis. As the mirrored component turns, the laser beam is successively reflected onto the stationary mirrors for reflection therefrom through the horizontal window as a scan pattern of the scan lines.

Instead of, or in addition to, a horizontal slot scanner, it is known to provide a vertical slot scanner, which is typically a portable reader placed on the countertop such that its window is generally vertical and faces an operator at the workstation. The generally vertical window is oriented generally perpendicularly to the horizontal window, or is slightly rearwardly inclined. The scan pattern generator within the workstation also projects the multitude of scan lines in a generally outward direction through the vertical window toward the operator. The generator for the vertical window can be the same as or different from the generator for the horizontal window. The operator slides or swipes the products past either window from right to left, or from left to right, in a “swipe” mode. Alternatively, the operator merely presents the symbol on the product to the center of either window in a “presentation” mode. The choice depends on operator preference or on the layout of the workstation.

Each product must be oriented by the operator with the symbol facing away from the operator and directly towards either window. Hence, the operator cannot see exactly where the symbol is during scanning. In typical “blind-aiming” usage, it is not uncommon for the operator to repeatedly swipe or present a single symbol several times before the symbol is successfully read, thereby slowing down transaction processing and reducing productivity.

The blind-aiming of the symbol is made more difficult because the position and orientation of the symbol are variable. The symbol may be located low or high, or right or left, on the product, or anywhere in between. The symbol may be oriented in a “picket fence” orientation in which the elongated parallel bars of the one-dimensional UPC symbol are vertical, or in a “ladder” orientation in which the symbol bars are horizontal, or at any orientation angle in between.

These point-of-transaction workstations have been long used for processing transactions involving products associated with one-dimensional symbols each having a row of bars and spaces spaced apart along one direction, and recently used for processing two-dimensional symbols, such as Code 49, as well. Code 49 introduced the concept of vertically stacking a plurality of rows of bar and space patterns in a single symbol. The structure of Code 49 is described in U.S. Pat. No. 4,794,239. Another two-dimensional code structure for increasing the amount of data that can be represented or stored on a given amount of surface area is known as PDF417 and is described in U.S. Pat. No. 5,304,786. Such two-dimensional symbols are generally read by electro-optical readers operative for projecting a laser beam as a raster of scan lines, each line extending in one direction over a respective row, and all the lines being spaced apart along a height of the two-dimensional symbol in a generally perpendicular direction.

Both one- and two-dimensional symbols can also be read by employing solid-state imaging readers. For example, an imager may be employed which has a one- or two-dimensional array of cells or photosensors, which correspond to image elements or pixels in a field of view of the imager. Such an imaging reader may include a one- or two-dimensional charge coupled imager (CCD) or a complementary metal oxide semiconductor (CMOS) imager and associated circuits for producing electronic signals corresponding to a one- or two-dimensional array of pixel information over the field of view. In addition to the aforementioned symbols, readers employing imagers can also read general two-dimensional symbols, such as DataMatrix, which cannot be read by existing laser-based readers.

It is therefore known to use a solid-state imager for capturing a monochrome image of a symbol as, for example, disclosed in U.S. Pat. No. 5,703,349. It is also known to use a solid-state imager with multiple buried channels for capturing a full color image of a target as, for example, disclosed in U.S. Pat. No. 4,613,895. It is common to provide a two-dimensional CCD with a 640×480 resolution commonly found in VGA monitors, although other resolution sizes are possible.

Thus, the known point-of-transaction workstations utilize solid-state imagers for capturing images of targets, especially two-dimensional symbols required to be electro-optically read, over a field of view that has the same aspect ratio as a conventional television picture, namely that its horizontal dimension is larger than its vertical dimension.

Although generally satisfactory for its intended purpose, this particular orientation of the field of view has some disadvantages. For example, the window through which the light is captured is made more wide than high to accommodate the greater horizontal dimension of the field of view and this, in turn, causes the housing of the reader to be made wider, as considered from side-to-side. Such a wide housing is not easy to grasp and pick up with one hand in order to read a symbol on a product that cannot easily be brought to the reader. Another disadvantage of a wide and short field of view is that some symbols, especially on tall products, may be positioned partially or fully above or below the window and may miss being read through the window during either the presentation or the swipe mode, and fail to be read.

The known imager-based reader is further disadvantageous in that it occupies a relatively large footprint on the countertop, which is especially undesirable on a small countertop where space is at a premium. Also, it is not tiltable relative to the countertop, nor is it mountable in a stand that is pivotably attached to the reader. In addition, the imager of the known reader directly faces a window, resulting in a short optical path within the workstation and a corresponding small field of view at the window. The known reader typically runs continuously to capture images, even when lifted from the countertop, which can overburden the image processing circuitry. Providing a manual action trigger to initiate reading eases this burden, but the trigger is typically placed in an awkward location, thereby making it difficult to actuate, especially when the reader is lifted from the countertop. The known imager-based reader utilizes many printed circuit boards and a corresponding large number of ribbon cables and connectors, thereby making it difficult and expensive to assemble.

### SUMMARY OF THE INVENTION

One feature of the present invention resides, briefly stated, in a reader for electro-optically reading a target, especially one-dimensional symbols, two-dimensional symbols, or documents. The reader is preferably embodied as a portable housing having a window. During reading, the target is swiped past the window during a swipe mode, or is presented to the window of the reader during a presentation mode. In the preferred embodiment, the reader is installed in a retail establishment, such as a supermarket, but can be installed virtually anywhere requiring targets to be read.

The window is preferably a sheet of light-transmissive plastic or glass, and its primary function is to keep dust and like contaminants out of the housing of the reader. The window need not be positioned at the front of the housing, but may be recessed within the housing well away from the front to minimize reflections at the window, thereby leaving a bare opening or aperture at the front of the housing. The window need not be in a vertical plane, but can be oriented at any angle relative to the front of the housing, and preferably is curved. For these reasons, the window is sometimes referred to herein as a “scanning aperture” or as a target “presentation area”.

A one- or two-dimensional, solid-state imager is mounted in the reader, and includes an array of image sensors operative for capturing light from a one-dimensional and/or a two-dimensional target passing through the presentation area over a field of view during the reading. Preferably, the array is a CCD array, but could be a CMOS array. The imager may be associated with a high-speed strobe illuminator under control of a controller to enable the image of the target to be acquired in a very short period of time, for example, on the order of 500 microseconds, so that the target image is not blurred even if there is relative motion between the imager and the target. The strobe illumination is preferably brighter than ambient illumination, especially close to the presentation area. The illumination can also be continuous. The imager captures light over an exposure time period, also under the control of the controller. A short exposure time also prevents image blurring.

The illuminator preferably includes a plurality of light emitting diodes (LEDs) for illuminating the target with illumination light exiting the window around a periphery thereof. The controller controls the illumination of the LEDs. The curved window is juxtaposed with the LEDs to reduce internal reflections of the illumination light at the window. A pair of printed circuit boards is mounted in mutual parallelism within the housing at different distances from the presentation area. Some of the LEDs are mounted on one of the boards, and others of the LEDs are mounted on the other of the boards.

As noted above, the conventional imager of the prior art is mounted in an imaging reader so that its field of view has the same aspect ratio as a conventional television picture, namely, that its horizontal dimension is larger than its vertical dimension. The solid-state imager described herein has a tall field of view, namely, that its vertical dimension is larger than its horizontal dimension. During the swipe mode, the user swipes the product bearing the symbol in a generally horizontal motion across the presentation area. As noted above, the symbol faces away from the user and, as a result of this blind aiming, some symbols fail to be read because they are not registered in the presentation area. Increasing the vertical height of the presentation area to accommodate a tall field of view reduces the chance of such reading failure, especially for elongated products where the symbol is positioned partially or fully above or below the presentation area during the swiping motion.

There is a group of documents such as driver's licenses, customer loyalty cards, membership cards, cash register paper receipts, credit/debit card transaction receipts requiring customer signatures, etc., that often are desired to be imaged as part of a point-of sale transaction, regardless of whether they bear a symbol. The image of each such document is captured by the solid-state imager by positioning each such document at the presentation area of the reader. A tall field of view and a tall window make it especially convenient to capture the entire image of each such document.

Ideally, the housing of an imaging reader should be small enough for a user to easily pick it up to read large, heavy, or bulky products that cannot easily be brought to the reader. By locating the imager at an elevation below the window, instead of at the same elevation as the window, the housing itself is configured with a narrow depth, thereby enabling easy handling. In addition, the narrow depth is achieved by providing a pair of folding mirrors in the housing between front and rear walls thereof. One of the folding mirrors directly faces the window. The imager faces the other of the folding mirrors to capture the light successively reflected off the pair of folding mirrors along a double-folded optical path. Advantageously, the one folding mirror is spaced from the window at a first horizontal distance, and the other folding mirror is spaced from the imager at a second horizontal distance, and the pair of folding mirrors is spaced apart by a third vertical distance larger than the first and second distances to space the front and rear walls apart by a spacing or depth dimension smaller than a spacing or height dimension between top and bottom walls of the housing. To make the reader even smaller in depth, a cable connector is mounted inside the housing between the front and rear walls thereof, rather than outside the housing, and a cable strain relief extends through the rear wall.

In accordance with another feature of this invention, a stand is provided for supporting the reader on a generally planar support surface. The housing of the reader is pivotably mounted on the stand to enable the housing to be tilted relative to the support surface. The stand is attached to the housing to form a portable reading assembly that rests on the support surface for reading the target in a hands-free mode of operation. The portable reading assembly is manually lifted off and removed from the support surface by the user for reading the target in a hand-held mode of operation.

A sensor is supported by the housing for determining whether the assembly is in the hands-free or the hand-held mode of operation. A controller is operatively connected to the sensor and the imager for controlling the imager to continuously capture light from the target in the hands-free mode of operation, and to manually capture light from the target in the hand-held mode of operation. A manually actuatable trigger is conveniently mounted on a side wall of the housing away from a top wall thereof, for signaling the controller to manually capture light from the target in the hand-held mode of operation each time the trigger is manually actuated. Preferably, the sensor is an accelerometer for determining acceleration of the assembly above a predefined threshold when the assembly is removed from the support surface to the hand-held mode of operation.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a point-of-transaction workstation operative for capturing light from two-dimensional targets in accordance with the prior art;

FIG. 2 is a schematic block diagram of various components of an imaging reader used in the workstation of FIG. 1 in accordance with the prior art;

FIG. 3 is a front perspective representation of an imaging reader mounted in a stand in accordance with the present invention;

FIG. 4 is a rear perspective representation of the imaging reader of FIG. 3;

FIG. 5 is a front perspective view analogous to FIG. 3, with the reader and the stand shown in phantom view to show the electrical and optical components therein;

FIG. 6 is a side elevational view of FIG. 5, again with the reader and the stand shown in phantom view;

FIG. 7 is a top plan view of FIG. 5, again with the reader and the stand shown in phantom view; and

FIG. 8 is a front elevational view of FIG. 5, again with the reader and the stand shown in phantom view.

### DETAILED DESCRIPTION OF THE PREFERRED EMBODIMENTS

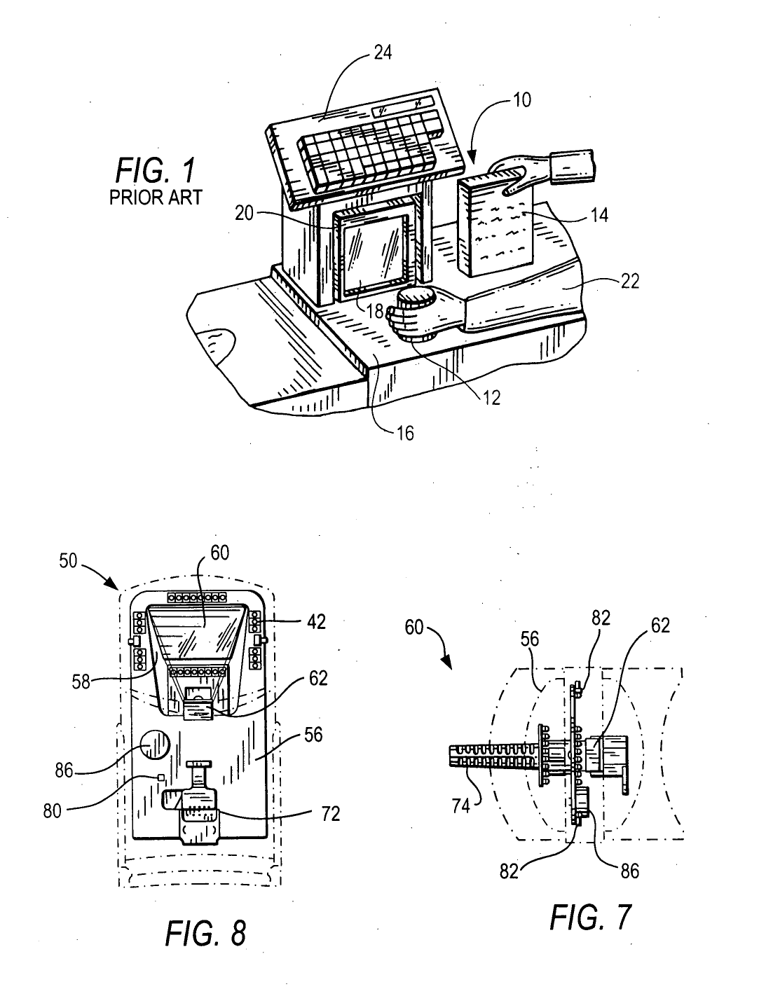

Reference numeral 10 in FIG. 1 generally identifies a workstation in accordance with the prior art for processing transactions and specifically a checkout counter at a retail site at which products, such as a can 12 or a box 14, each bearing a target symbol, are processed for purchase. The counter includes a countertop 16 across which the products are slid at a swipe speed past a vertical square window 18 of a box-shaped vertical slot imager or reader 20 mounted on the countertop 16. A checkout clerk or operator 22 is located at one side of the countertop, and the reader 20 is located at the opposite side. A cash/credit register 24 is located within easy reach of the operator.

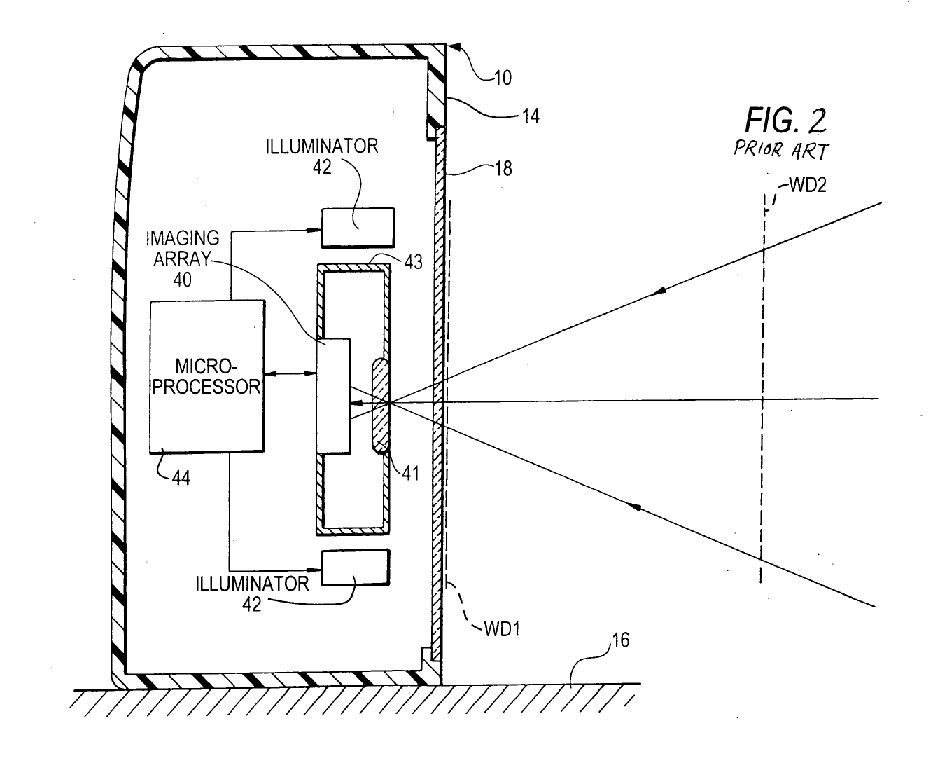

As shown in FIG. 2, in further accordance with the prior art, the vertical slot reader generally includes an imager or imaging array 40 and a focusing lens 41 mounted in an enclosure 43. The imager 40 is a solid-state device, for example, a CCD or a CMOS imager and has a one- or two-dimensional array of addressable image sensors operative for capturing light through the window 18 from a target over a field of view and located in a working range of distances between a close-in working distance (WD1) and a far-out working distance (WD2). Typically, WD1 is about two inches from the imager 40 and generally coincides with the window 18, and WD2 is about eight inches from the window 18. An illuminator 42 is also mounted in the reader and preferably includes a plurality of light sources, e.g., light emitting diodes (LEDs) arranged around the array 40 to uniformly illuminate the target.

As also shown in FIG. 2, the imager 40 and the illuminator 42 are operatively connected to a controller or microprocessor 36 operative for controlling the operation of these components. Preferably, the microprocessor is the same as the one used for decoding light scattered from the indicia and for processing the captured target images.

In operation, the microprocessor 36 sends a command signal to the illuminator 42 to pulse the LEDs for a short time period of 500 microseconds or less, and energizes the imager 40 to collect light from a target substantially only during said time period. A typical array needs about 33 milliseconds to read the entire target image and operates at a frame rate of about 30 frames per second. The array may have on the order of one million addressable image sensors.

The field of view of the prior art imager 40 of FIGS. 1-2, as viewed in a direction perpendicular to the window 18, is generally rectangular and has a greater horizontal dimension (width) than its vertical dimension (height), and has an aspect ratio on the order of 4:3, which corresponds to that of a standard television picture. The field of view can be described as short and wide, and the window 18 has similar dimensions, thereby resulting in the drawbacks described above.

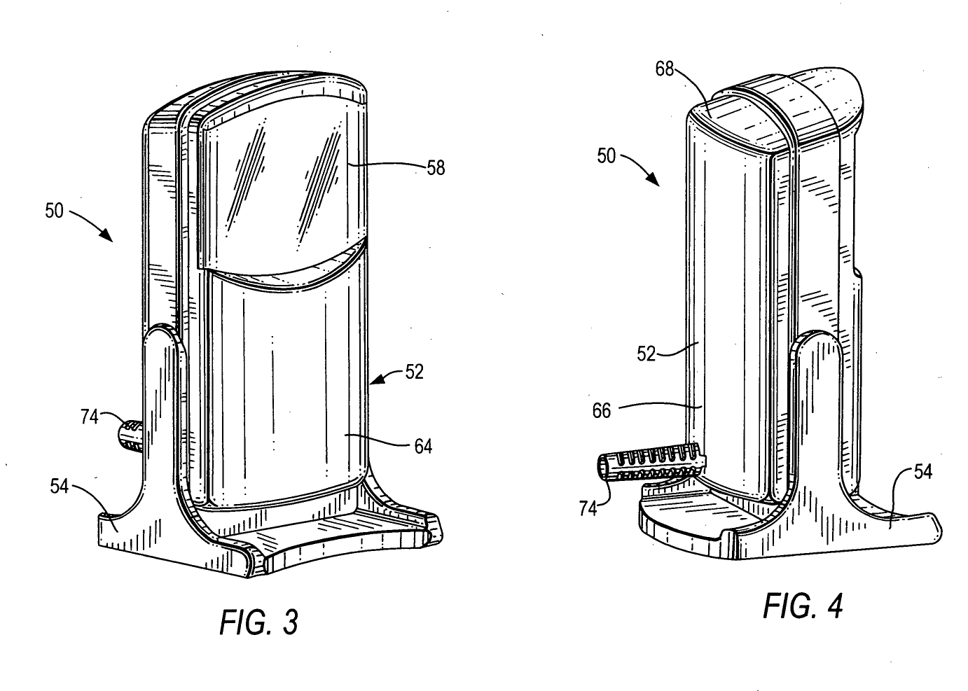

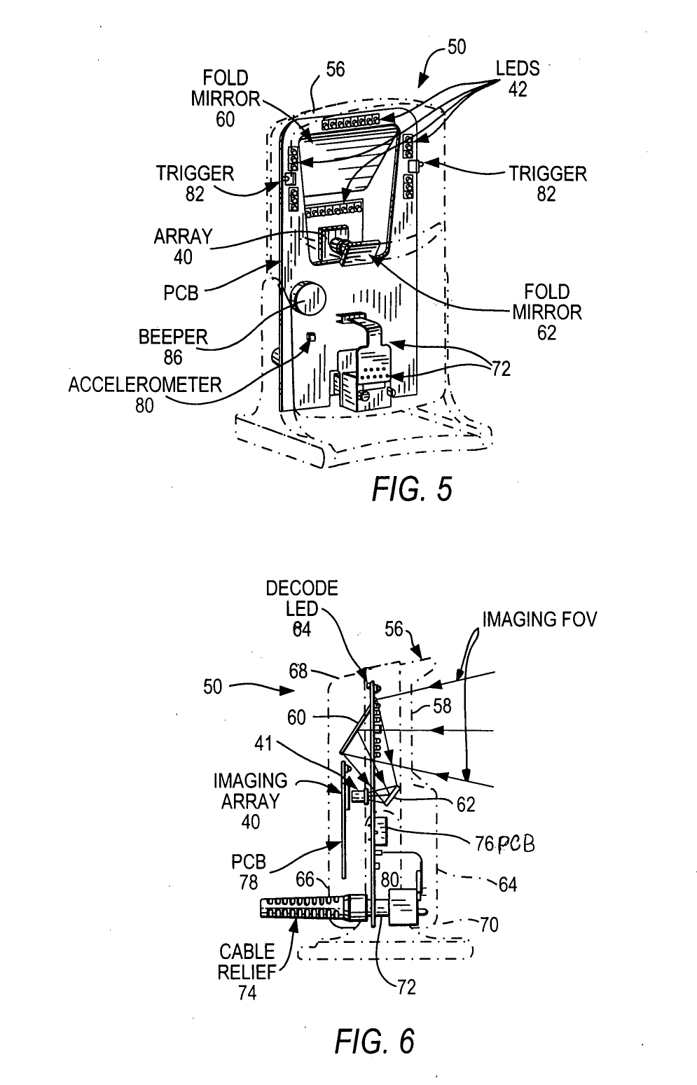

In accordance with one feature of this invention, as shown in FIGS. 3-8, a portable reading assembly 50 including a reader 52 and a stand 54 is mounted on a generally planar support surface, such as the countertop 16 (or on a vertical or inclined surface, with the aid of fasteners extending through holes in the stand) for reading the target in a hands-free mode of operation. The reader 52 is pivotably mounted on the stand 54 about a horizontal axis to enable the reader 52 to be tilted relative to the support surface. Some users prefer to lean the reader forward on its stand to allow easy reading of hangtags. The pivot axis should ideally be a few inches above the support surface, typically not more than 55% and not less than 20% of the height of the reader. The portable reading assembly 50, with the reader and the attached stand, may also be manually lifted off and removed from the support surface by the user for reading the target in a hand-held mode of operation. By attaching the stand to the reader, a separated reader need not be carefully placed back in a separate stand.

The reader 52 has a tall and narrow in depth, rectangular housing 56 in which a curved, recessed window (or presentation area) 58 is supported to capture light from a target, e.g., a one-dimensional symbol, a two-dimensional symbol, a document, a person, etc., over a field of view of the aforementioned imager 40. The housing 56 is narrow in depth enough for a user to easily pick it up in the hand-held mode to read large, heavy, or bulky products that cannot easily be brought to the reader. By locating the imager 40, as best shown in FIG. 6, at an elevation below the window 58, instead of at the same elevation as the window, the housing 56 itself is configured with a narrow depth, thereby enabling easy handling. Hence, the window 58 is located as close as possible to the top of the housing and as high as possible relative to the support surface 16, while minimizing the height of the housing. A front wall 64 is also curved. Preferably, the window occupies more than 25% of the area of the front wall. A rear wall 66 of the housing is curved to easily fit in the palm of the user's hand. The width of the housing is small and little wider than the window, making the housing convenient to grasp.

In addition, the narrow depth is achieved by providing a pair of folding mirrors 60, 62 in the housing between the front 64 and rear 66 walls thereof. One of the folding mirrors 60 directly faces the window 58 at an upper elevation. The array 40 faces the other of the folding mirrors 62 at a lower elevation to capture the light successively reflected off the pair of folding mirrors along a double-folded optical path. Advantageously, the folding mirror 60 is spaced from the window 58 at a first horizontal distance, and the other folding mirror 62 is spaced from the array 40 at a second horizontal distance, and the pair of folding mirrors 60, 62 is spaced apart by a third vertical distance larger than the first and second distances to space the front 64 and rear 66 walls apart by a spacing or depth dimension smaller than a spacing or height dimension between top 68 and bottom 70 walls of the housing. The pair of folding mirrors 60, 62 allows the front-to-back dimension of the housing 56 to be reduced. This minimizes the size of the reader footprint, which is often important in crowded work environments such a retail point-of-sale workstation. The pair of folding mirrors 60, 62 also enables the field of view to be as large as possible at the window 58.

The folding mirrors and the structure that joins them can be molded as a single piece of plastic, and can even support the imager 40. This structure can be mounted on the housing, or on one of the circuit boards described below.

To make the reader housing 56 even narrower in depth, a cable connector 72 is mounted inside the housing between the front 64 and rear 66 walls thereof, rather than outside the housing, and as close to the front wall 64 as possible. A cable strain relief 74 extends through the rear wall 66. The relief 74 to which a cable is attached is situated very low on the housing so as not to interfere with the user's grasp of the housing.

The stand 54 is preferably molded out of a single piece of plastic and has a pair of resilient upright arms between which the reader is mounted with a snap action. The arms have aligned projections that extend into recesses in the housing. Preferably, there is a plurality of such recesses arranged in an arc concentric with the pivot axis to allow the housing to be held in different angular positions. A weight can be added to a bottom of the stand to increase stability.

The field of view of the imager 40 as viewed in a direction perpendicular to the window 58, is generally rectangular and has a greater vertical dimension (height) than its horizontal dimension (width), The field of view can be described as tall and narrow, and the window 58 has similar dimensions, thereby resulting in the advantages described above.

The target can be a driver's license, and some retailers wish to be able to read the two-dimensional PDF 417 symbol that is printed on the back of many such licenses. This symbol contains such information as the driver's name, address, date of birth, etc., and some retailers wish to capture such information automatically to facilitate automatic population of forms such as credit card applications, as well as age verification for purchasing alcoholic and tobacco products. A tall field of view enables the entire symbol, or the entire license to be imaged.

Another use of the tall field of view is to facilitate signature capture on credit card transaction receipts. Rather than capturing one's signature electronically, either by asking the customer to write on a special signature capture pad on which the customer sees his or her signature appear on a display as it is written, or to write on a paper receipt which is placed on a pressure-sensitive pad during the time that the signature is written, the imager 40 of this invention can capture the signature, without using a separate piece of equipment. Thus, the customer would sign the customary paper receipt, whose image would then be captured.

The LEDs of the illuminator 42 are arranged in horizontal and vertical rows for illuminating the target with illumination light exiting the window 58 around a periphery thereof. The aforementioned controller 36 controls the illumination of the LEDs. The LEDs can be illuminated all at once, or only some of them during each exposure of the imager. For example, the vertical row of the LEDs on the left side of the window can be illuminated for some exposures to enable the imager to capture light from part of the symbol, and the vertical row of the LEDs on the right side of the window can be illuminated for other exposures to enable the imager to capture light from a remaining part of the symbol, thereby requiring both parts to be stitched together. Other combinations of the LEDs can be illuminated.

The curved window 58 is juxtaposed with the LEDs to reduce reflections of the illumination light at the window. The window can be molded of plastic, together with integral lenses to uniformly distribute the light over the field of view. Non-imaging reflectors can be molded into the window to collect as much light as possible from the LEDs and to uniformly distribute this light. A pair of printed circuit boards (PCBs) 76, 78 is mounted in mutual parallelism within the housing at different distances from the window. Some of the LEDs, along with some of the electrical and optical components of the reader, are mounted on one of the boards, and others of the LEDs, along with other of the electrical and optical components of the reader, are mounted on the other of the boards. There are fewer ribbon cables, wires and connectors as compared to known readers which use multiple boards.

A sensor 80 is supported by the housing for determining whether the assembly 50 is in the hands-free or the hand-held mode of operation. The controller 36 is operatively connected to the sensor 80 and the imager 40 for controlling the imager to continuously capture light from the target in the hands-free mode of operation, and to manually capture light from the target in the hand-held mode of operation. A manually actuatable trigger 82 is mounted on a right and/or left side wall of the housing away from the top wall 68 thereof in the general vicinity where the user's forefinger would naturally lie, for signaling the controller 36 to manually capture light from the target in the hand-held mode of operation each time the trigger 82 is manually actuated. Preferably, the sensor 80 is at least one accelerometer for determining acceleration of the assembly 50 above a predefined, programmable threshold for a predetermined, programmable period of time when the assembly 50 is removed from the support surface 16 to the hand-held mode of operation.

When it has been determined that the assembly has been lifted off the support surface, then the reader automatically stops automatic scanning and waits for the trigger 82 to be actuated before attempting to read another symbol. If a symbol has been decoded, then a decode LED 84 and/or a beeper 86 advise the user that the symbol was successfully read, and the user must actuate the trigger again to read another symbol. This hand-held mode continues until the sensor 80 determines that the assembly 50 has been returned to the support surface, i.e., the sensor determines that the acceleration is below the threshold (no movement).

When it has been determined that the assembly has been lifted off the support surface, then one or more of the LEDs, or additional light sources, can be used to generate aiming light beams to visually designate an aiming pattern on a specific symbol from among a group of neighboring symbols in the field of view to thereby insure that only the designated symbol will be read, and that the designated symbol is in the field of view.

When it has been determined that the assembly has been lifted off the support surface, then one or more of the LEDs, or additional light sources, can be used to generate ranging light beams that converge in front of the reader at a predetermined distance therefrom. The predetermined distance corresponds to a distance in the working range that provides optimum scanning performance for a particular symbol or a particular reader. For example, the ranging beams project projection patterns, i.e., spots or lines or colors, on the symbol that can be used to advise the user of the ideal working distance to read a two-dimensional symbol on a driver's license. The user uses the ranging beams by changing the distance between the assembly and the symbol until the ranging beam patterns on the symbol are coincident or assume a predetermined relationship. Multiple sets of ranging beams can be used, one for each type of target.

To minimize image blurring, the controller 36 controls how long the LEDs will be energized, whether the energization is continuous or pulsed, the duty cycle of the LEDs, and the intensity of the illumination. In addition, the controller controls the exposure time period of the sensors of the imager 40. The shorter the exposure time period, and the shorter and brighter the illumination of the illuminator, the less likely there will be image blurring even if there is relative motion between the target and the window during reading.

Room exists within the housing for a radio frequency identification (RFID) device and/or an electronic article surveillance (EAS) deactivator to be incorporated in the reader. Room also exists for a rechargeable battery and/or a transceiver for transmitting and receiving signals over a wireless connection (e.g., BLUETOOTH™) to a remote host, such as a cash register. The transceiver can also be provided in the stand. When a rechargeable battery is used, then the reader is preferably detachably mounted on the stand. When the reader is off the stand, then the on-board batteries power the reader. When the reader is returned to the stand, then the on-board batteries are recharged, and data can be uploaded to or downloaded from the host.

It will be understood that each of the elements described above, or two or more together, also may find a useful application in other types of constructions differing from the types described above. Thus, readers having different configurations can be used.

While the invention has been illustrated and described as a compact, ergonomic imaging reader, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. A reader for electro-optically reading a target, comprising:
a housing having a target presentation area; and
a solid-state imager in the housing at an elevation below the target presentation area and including an array of image sensors for capturing light through the presentation area from the target over a field of view.

2. The reader of claim 1; and a pair of folding mirrors in the housing between front and rear walls thereof, and wherein one of the folding mirrors directly faces the target presentation area, and wherein the imager faces the other of the folding mirrors to capture the light successively reflected off the pair of folding mirrors along a double-folded optical path.

3. The reader of claim 2, wherein the one folding mirror is spaced from the target presentation area at a first horizontal distance, and wherein the other folding mirror is spaced from the imager at a second horizontal distance, and wherein the pair of folding mirrors is spaced apart by a third vertical distance larger than the first and second distances to space the front and rear walls apart by a spacing smaller than a spacing between top and bottom walls of the housing.

4. The reader of claim 1, wherein the field of view has an aspect ratio whose vertical dimension is larger than its horizontal dimension during reading.

5. The reader of claim 1; and a stand for supporting the housing on a generally planar support surface, the housing being pivotably mounted on the stand to enable the housing to be tilted relative to the support surface.

6. The reader of claim 5, wherein the stand is attached to the housing to form a portable reading assembly on the support surface for reading the target in a hands-free mode of operation, and wherein the portable reading assembly is manually lifted off and removed from the support surface for reading the target in a hand-held mode of operation.

7. The reader of claim 6; and a sensor supported by the housing for determining whether the assembly is in the hands-free or the hand-held mode of operation, and a controller operatively connected to the sensor and the imager for controlling the imager to continuously capture light from the target in the hands-free mode of operation, and to manually capture light from the target in the hand-held mode of operation.

8. The reader of claim 7; and a manually actuatable trigger mounted on a side wall of the housing away from a top wall thereof, for signaling the controller to manually capture light from the target in the hand-held mode of operation each time the trigger is manually actuated.

9. The reader of claim 7, wherein the sensor is an accelerometer for determining acceleration of the assembly above a predefined threshold when the assembly is removed from the support surface to the hand-held mode of operation.

10. The reader of claim 1; and a cable connector mounted inside the housing between front and rear walls wall thereof, and a cable strain relief extending through the rear wall.

11. The reader of claim 1; and an illuminator including a plurality of light emitting diodes (LEDs) for illuminating the target with illumination light exiting the presentation area around a periphery thereof, and a controller for controlling illumination of the LEDs.

12. The reader of claim 11; and a pair of printed circuit boards mounted in mutual parallelism within the housing at different distances from the presentation area, and wherein some of the LEDs are mounted on one of the boards, and wherein others of the LEDs are mounted on the other of the boards.

13. The reader of claim 11, wherein the presentation area comprises a curved window juxtaposed with the LEDs to reduce reflections of the illumination light at the window.

14. The reader of claim 1, wherein the target is at least one selected from a group including a one-dimensional symbol, a two-dimensional symbol, and a document.

15. The reader of claim 1, wherein the imager is one of a charge coupled device and a complementary metal oxide silicon device.

16. A reader for electro-optically reading a target, comprising:
means for providing a target presentation area; and
means including an array of image sensors located at an elevation below the target presentation area, for capturing light through the presentation area from the target over a field of view.

17. A method of electro-optically reading a target, comprising the steps of:
positioning a presentation area on a housing of an electro-optical reader; and
capturing light through the presentation area from the target over a field of view with an array of image sensors of a solid-state imager located at an elevation below the target presentation area.

18. The method of claim 17; and mounting a pair of folding mirrors in the housing between front and rear walls thereof, and directly facing one of the folding mirrors with the target presentation area, and facing the imager with the other of the folding mirrors to capture the light successively reflected off the pair of folding mirrors along a double-folded optical path.

19. The method of claim 18, and spacing the one folding mirror from the target presentation area at a first horizontal distance, and spacing the other folding mirror from the imager at a second horizontal distance, and spacing the pair of folding mirrors apart by a third vertical distance larger than the first and second distances to space the front and rear walls apart by a spacing smaller than a spacing between top and bottom walls of the housing.

20. The method of claim 17, and configuring the field of view to have an aspect ratio whose vertical dimension is larger than its horizontal dimension during reading.

21. The method of claim 17; and supporting the housing with a stand on a generally planar support surface, and pivotably mounting the housing on the stand to enable the housing to be tilted relative to the support surface.

22. The method of claim 21, and attaching the stand to the housing to form a portable reading assembly, and supporting the portable reading assembly on the support surface for reading the target in a hands-free mode of operation, and manually lifting the portable reading assembly off the support surface for reading the target in a hand-held mode of operation.

23. The method of claim 22; and determining whether the assembly is in the hands-free or the hand-held mode of operation, and controlling the imager to continuously capture light from the target in the hands-free mode of operation, and to manually capture light from the target in the hand-held mode of operation.

24. The method of claim 23; and mounting a manually actuatable trigger mounted on a side wall of the housing away from a top wall thereof, for manually capturing light from the target in the hand-held mode of operation each time the trigger is manually actuated.

25. The method of claim 23, wherein the determining step is performed by determining acceleration of the assembly above a predefined threshold when the assembly is lifted from the support surface to the hand-held mode of operation.

26. The method of claim 17; and mounting a cable connector inside the housing between front and rear walls wall thereof, and extending a cable strain relief through the rear wall.

27. The method of claim 17; and illuminating the target with illumination light exiting the presentation area around a periphery thereof with a plurality of light emitting diodes (LEDs), and controlling illumination of the LEDs.

28. The method of claim 27; and mounting a pair of printed circuit boards in mutual parallelism within the housing at different distances from the presentation area, and mounting some of the LEDs on one of the boards, and mounting others of the LEDs on the other of the boards.

29. The method of claim 27, and configuring the presentation area as a curved window juxtaposed with the LEDs to reduce reflections of the illumination light at the window.

30. The method of claim 17, and selecting the target to be at least one from a group including a one-dimensional symbol, a two-dimensional symbol, and a document.

31. The method of claim 17, and selecting the imager to be one of a charge coupled device and a complementary metal oxide silicon device.
